(19) United States
(12) Patent Application Publication
(10) Pub. No.: US 2010/0169687 A1
(43) Pub. Date: Jul. 1, 2010

(54) DATA STORAGE DEVICE AND POWER-SAVING CONTROL METHOD FOR DATA STORAGE DEVICE

(75) Inventor: Yoshinobu Kimura, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/543,019

(22) Filed: Aug. 18, 2009

(30) Foreign Application Priority Data
Dec. 26, 2008 (JP) 2008-333239

(51) Int. Cl. G06F 1/32; G06F 1/04; G06F 12/00

(52) U.S. Cl. 713/324; 713/601; 711/103; 711/E12.001; 711/E12.008

(57) ABSTRACT

A data storage device includes a first nonvolatile memory, a second volatile memory that temporarily stores therein data to be transferred between a host device and the first memory, a first control unit that controls the second memory, a second control unit that controls data transfer between the first control unit and the first memory, a third control unit that controls data transfer between the host device and the first control unit, and a clock stop unit that stops a clock signal supplied to the first to third control units in conjunction with a power consumption control of the third control unit to perform a power saving control.

### CROSS-REFERENCE TO RELATED APPLICATIONS

This application is based upon and claims the benefit of priority from the prior Japanese Patent Application No. 2008-333239, filed on Dec. 26, 2008; the entire contents of which are incorporated herein by reference.

### BACKGROUND OF THE INVENTION

1. Field of the Invention

The present invention relates to a data storage device, and a power-saving control method for a data storage device.

2. Description of the Related Art

Serial Advanced Technology Attachment (SATA) is one of standards for connection of data storage devices such as a hard disk drive (HDD). The SATA standard defines power saving modes such as a PARTIAL mode and a SLUMBER mode.

A data storage device has a SATA interface circuit with a function of shifting the device to a power saving mode that meets the SATA standard according to a request received from a host device. For example, an interface circuit disclosed in Japanese Patent Application Laid-open No. 2005-216046 shifts a device to a power saving mode by stopping a clock for an analog circuit part and a digital circuit part that digitalizes transmitted or received data of a SATA interface.

Recently, a solid state drive (SSD) mounted with a nonvolatile semiconductor memory such as an inverted AND (NAND) flash memory (hereinafter, simply as “NAND memory”) has attracted attention as a data storage device capable of connection according to the SATA. The SSD is more advantageous than the HDD because it is high in speed and light in weight.

### BRIEF SUMMARY OF THE INVENTION

A data storage device according to an embodiment of the present invention comprises: a first nonvolatile memory; a second volatile memory that temporarily stores therein data to be transferred between a host device and the first memory; a first control unit that controls the second memory; a second control unit that controls data transfer between the first control unit and the first memory; a third control unit that controls data transfer between the host device and the first control unit; and a clock stop unit that stops a clock signal supplied to the first to third control units in conjunction with a power consumption control of the third control unit to perform a power saving control.

A data storage device according to an embodiment of the present invention comprises: a nonvolatile memory; a first control unit that controls the memory; a second control unit that controls data transfer between a host device and the first control unit; and a clock stop unit that stops a clock signal supplied to the first and second control units in conjunction with a power consumption control of the second control unit to perform a power saving control.

A power-saving control method for a data storage device that includes a first nonvolatile memory, a second volatile memory that temporarily stores therein data to be transferred between a host device and the first memory, a first control unit that controls the second memory, a second control unit that controls data transfer between the first control unit and the first memory, and a third control unit that controls data transfer between the host device and the first control unit, according to an embodiment of the present invention comprises stopping a clock signal supplied to the first to third control units in conjunction with a power consumption control of the third control unit to perform a power saving control.

### BRIEF DESCRIPTION OF THE DRAWINGS

FIG. 1 is a block diagram for explaining a configuration of a SSD according to an embodiment of the present invention;

FIG. 2 is a flowchart for explaining an operation of the SSD according to the embodiment;

FIG. 3 is a flowchart for explaining another operation of the SSD according to the embodiment;

FIG. 4 is a flowchart for explaining still another operation of the SSD according to the embodiment;

FIG. 5 is a flowchart for explaining still another operation of the SSD according to the embodiment;

FIG. 6 is a flowchart for explaining still another operation of the SSD according to the embodiment;

FIG. 7 is a sequence diagram for explaining an operation of the SSD according to the embodiment in detail;

FIG. 8 is a sequence diagram for explaining another operation of the SSD according to the embodiment in detail;

FIG. 9 is a sequence diagram for explaining still another operation of the SSD according to the embodiment in detail; and

FIG. 10 is a sequence diagram for explaining an operation of a conventional SSD in detail.

### DETAILED DESCRIPTION OF THE INVENTION

A SSD includes a controller circuit that controls a buffer memory for transfer data, and a controller circuit that controls a NAND memory, in addition to a SATA interface circuit, to execute data transfer between the NAND memory and a host device. In a power saving mode of a typical SSD, controller circuits other than the SATA interface circuit operate in a data transmission/reception wait state even when no data is transmitted or received. Accordingly, there is still room for reduction in the power consumption.

In view of the problems found by the present inventors, exemplary embodiments of a data storage device and a power-saving control method for a data storage device according to the present invention will be explained below in detail with reference to the accompanying drawings. The present invention is not limited to the embodiments.

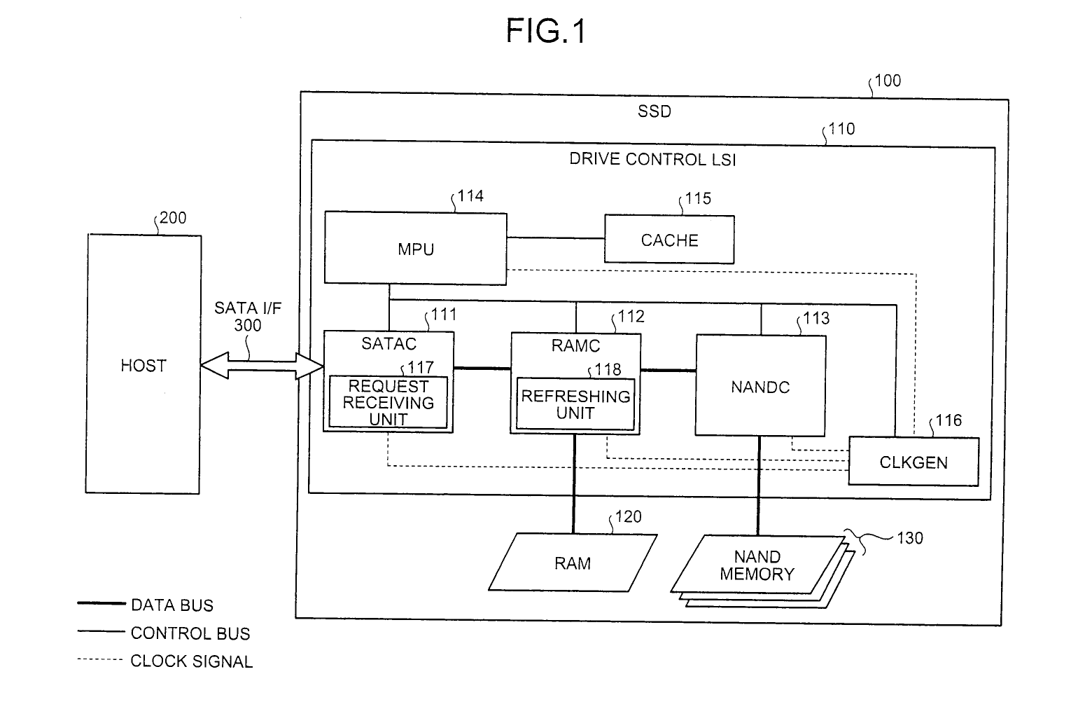

FIG. 1 is a block diagram of a configuration of a data storage device according to an embodiment of the present invention. The SSD is used here as an example of the data storage device; however, the SSD is not the only target to which the present embodiment can be applied. For example, the present embodiment can be also applied to a memory card removable from the host device, or a built-in system installed in a mobile phone.

An SSD 100 is connected to a host device (Host) 200 such as a personal computer through a SATA interface (I/F) 300 as a serial interface, to operate as an external storage device of the Host 200. The Host 200 transmits a request to the SSD 100 to shift the SSD 100 to a power saving mode or recover the SSD 100 from the power saving mode according to statues of data access to the SSD 100.

The SSD 100 includes a NAND memory 130 as a nonvolatile memory that stores therein data to be read from or written into the Host 200, a drive control large-scale integration (LSI) 110 that performs a data transfer control for the SSD 100, and a random access memory (RAM) 120 as a volatile memory that temporarily stores therein transfer data for data transfer by the drive control LSI 110. The RAM 120 operates as a data cache memory for the NAND memory 130, and can be a dynamic RAM (DRAM), for example.

The drive control LSI 110 further includes a SATA interface controller (SATAC) 111, a RAM controller (RAMC) 112, and a NAND controller (NANDC) 113. The SATAC 111 and the RAMC 112, the RAMC 112 and the NANDC 113, the RAMC 112 and the RAM 120, and the NANDC 113 and the NAND memory 130 are connected through a data bus for transferring data, respectively. The SATAC 111 controls the SATA I/F 300, and controls data transfer between the Host 200 and the RAM 120. The RAMC 112 controls read or write of data from/into the RAM 120. The NANDC 113 controls read or write from/into the NAND memory 130, and controls data transfer between the NAND memory 130 and the RAM 120.

The drive control LSI 110 further includes a microprocessor unit (MPU) 114 that entirely controls the drive control LSI 110 by running firmware, a cache 115 as a cache memory, and a clock generating circuit (CLKGEN) 116 that supplies a clock signal to the constituent elements included in the drive control LSI 110. The MPU 114, the SATAC 111, the RAMC 112, the NANDC 113, and the CLKGEN 116 are connected with each other via a control bus for transmitting or receiving a control signal. The MPU 114, the SATAC 111, the RAMC 112, and the NANDC 113 are individually connected with the CLKGEN 116 through a clock signal. The CLKGEN 116 can supply or stop a clock for the MPU 114, the SATAC 111, the RAMC 112, and the NAND 113 individually.

Upon receipt of a request from the Host 200 for shift to a power saving mode, the SATAC 111 issues an interrupt notification for shifting to the power saving mode to the MPU 114. Upon receipt of the interrupt notification, the MPU 114 instructs the CLKGEN 116 to stop supply of the clock signal to the SATAC 111, the RAMC 112, and the NANDC 113, which causes the SSD 100 to enter a power saving mode. That is, the MPU 114 and the CLKGEN 116 have a function as a clock stop unit that stops the clock signal supplied to the SATAC 111, the RAMC 112, and the NANDC 113 in conjunction with a power consumption control by the SATAC 111. Also in the power saving mode, the clock signal is kept supplied to a unit in the SATAC 111 that receives a request for recovery from the power saving mode (a request receiving unit 117), and a unit in the RAMC 112 that refreshes the RAM 120 (a refreshing unit 118).

The power saving modes defined in the SATA standard include a PARTIAL mode in which a time period required for recovery from the power saving mode needs to be equal to or shorter than 10 microseconds, and a SLUMBER mode in which the required time period needs to be equal to or shorter than 10 milliseconds. It is assumed in the present embodiment that the SSD 100 shifts to the state where the supply of the clock to the SATAC 111, the RAMC 112, and the NANDC 113 is stopped when the SLUMBER mode is requested. This state is referred to as “SSD power saving mode”.

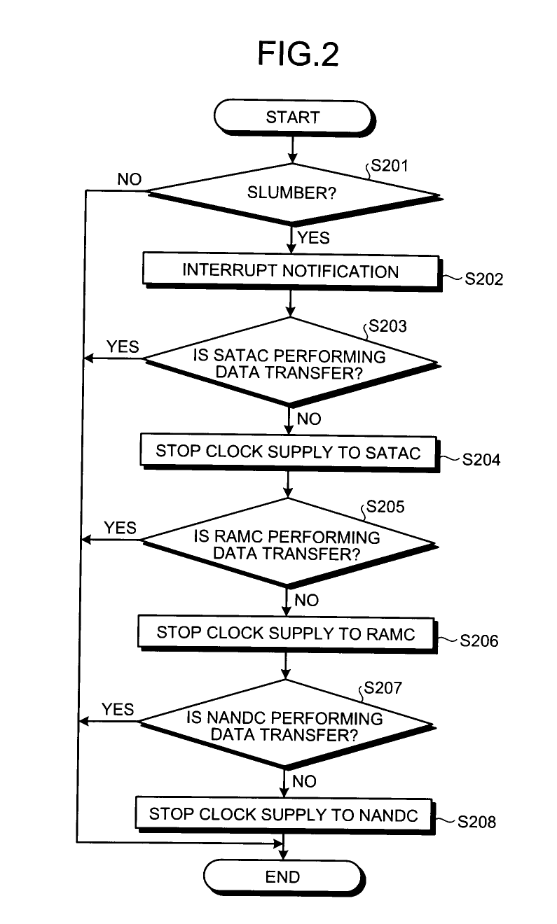

FIG. 2 is a flowchart for explaining an operation of the SSD 100 from receipt of a request from the Host 200 for shift to the power saving mode until entry into the SSD power saving mode. The SATAC 111 first receives a request from the Host 200 for shift to the power saving mode. The SATAC 111, which has received the request for shift to the power saving mode, determines whether the received request is for shifting to the SLUMBER mode (Step S201). When the received request is not for shifting to the SLUMBER mode (NO at Step S201), the operation for shifting to the SSD power saving mode is terminated. The present invention can be also applied to a case that the received request is for shifting to the PARTIAL mode, instead of the SLUMBER mode. For example, the SATAC 111 can stop the clock of its internal circuit to shift the SSD 100 to a power saving mode from which the SSD 100 can be recovered within 10 microseconds.

When the received request is for shifting to the SLUMBER mode (YES at Step S201), the SATAC 111 issues an interrupt notification for shifting to the SSD power saving mode to the MPU 114 (Step S202). The MPU 114 determines whether the SATAC 111 is performing a data transfer process of transmitting data received from the Host 200 to the RAMC 112 (Step S203). When the SATAC 111 has completed the data transfer process (NO at Step S203), the MPU 114 instructs the CLKGEN 116 to stop the supply of the clock signal to the SATAC 111 (Step S204). When the SATAC 111 is performing the data transfer process (YES at Step S203), the operation for shifting to the SSD power saving mode is terminated.

Following the process at Step S204, the MPU 114 determines whether the RAMC 112 is performing a data transfer process (Step S205). The data transfer process by the RAMC 112 in the present embodiment includes a process of writing data received from the SATAC 111 into the RAM 120, and a process of reading data to be transmitted to the NANDC 113 from the RAM 120 and transmitting the read data to the NANDC 113. When the RAMC 112 has completed the data transfer process (NO at Step S205), the MPU 114 instructs the CLKGEN 116 to stop the supply of the clock signal to the RAMC 112 (Step S206). When the RAMC 112 is performing the process associated with data transfer (YES at Step S205), the operation for shifting to the SSD power saving mode is terminated.

Following the process at Step S206, the MPU 114 determines whether the NANDC 113 is performing a data transfer process of writing data received from the RAMC 112 into the NAND memory 130 (Step S207). When the NANDC 113 has completed the data transfer process (NO at Step S207), the MPU 114 instructs the CLKGEN 116 to stop the clock signal supplied to the NANDC 113 (Step S208), and then the operation is terminated. When the NANDC 113 is performing the data transfer process (YES at Step S207), the operation for shifting to the SSD power saving mode is terminated.

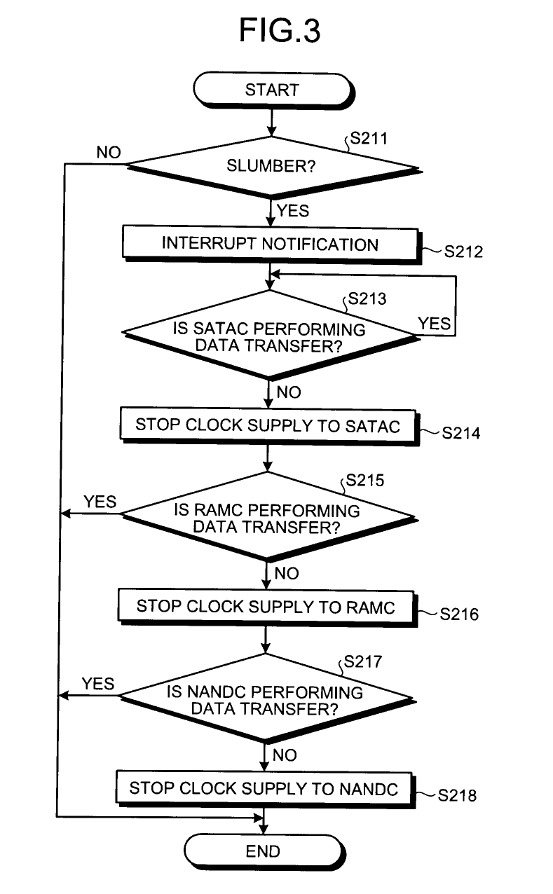

Although it has been explained that the operation for shifting to the SSD power saving mode is terminated when the SATAC 111 is performing the data transfer process (YES at Step S203), the SSD 100 can wait for completion of the data transfer process when the SATAC 11 is performing the data transfer process. FIG. 3 is a flowchart of an operation of the SSD 100 in which completion of the data transfer process by the SATAC 111 is waited. As shown in FIG. 3, the same processes at Steps S201 and S202 are performed in processes at Steps S211 and S212, respectively. After the process at Step S212, the MPU 114 determines whether the SATAC 111 is performing the data transfer process of transmitting the data received from the Host 200 to the RAMC 112 (Step S213). When the SATAC 111 has completed the data transfer process (NO at Step S213), the MPU 114 instructs the CLKGEN 116 to stop the supply of the clock signal to the SATAC 111 (Step S214). When the SATAC 111 is performing the data transfer process (YES at Step 213), the MPU 114 continues the determination at Step S213 until the SATAC 111 completes the data transfer process. Processes after Step S214 are the same as those after Step S204, and thus explanations thereof will be omitted.

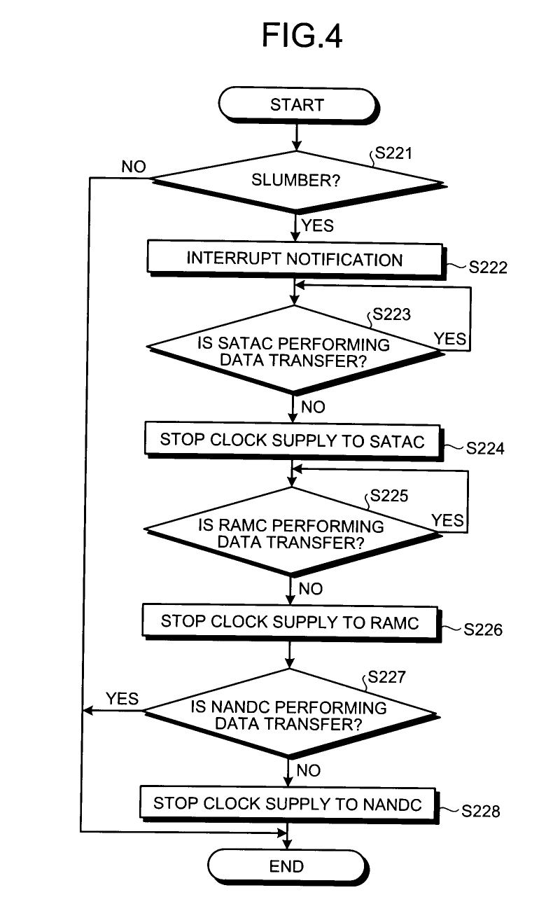

Similarly, even when the PAMC 112 is performing the data transfer process, the SSD 100 can wait until the RAMC 112 completes the data transfer process, instead of terminating the operation of shifting to the SSD power saving mode. FIG. 4 is a flowchart of an operation of the SSD 100 in which completion of the data transfer process by the RAMC 112 is waited. The same processes at Steps S211 to S214 are performed in processes at Steps S221 to S224, respectively. After the process at Step S224, the MPU 114 determines whether the RAMC 112 is performing the data transfer process (Step S225). When the RAMC 112 has completed the data transfer process (NO at Step S225), the MPU 114 instructs the CLKGEN 116 to stop the supply of the clock signal to the RAMC 112 (Step S226). When the RAMC 112 is performing the data transfer process (YES at Step S225), the MPU 114 continues the determination at Step S225 until the RAMC 112 completes the data transfer process. Processes after Step S226 are the same as those after Step S216.

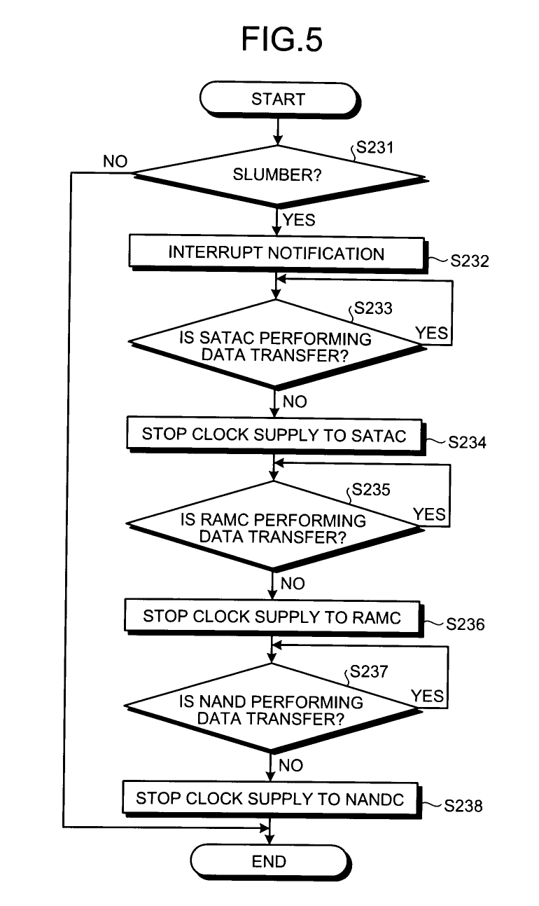

Similarly, also when the NANDC 113 is performing the data transfer process, the SSD 100 can wait until the NANDC 113 completes the data transfer process, instead of terminating the operation of shifting to the SSD power saving mode. FIG. 5 is a flowchart of an operation of the SSD 100 in which completion of the data transfer process by the NANDC 113 is waited. The same processes at Step S221 to S226 are performed in processes at Step S231 to S236, respectively. After the process at Step S236, the MPU 114 determines whether the NANDC 113 is performing the data transfer process (Step S237). When the NANDC 113 has completed the data transfer process (NO at Step S237), the MPU 114 instructs the CLKGEN 116 to stop the supply of the clock signal to the NANDC 113 (Step S238). When the NANDC 113 is performing the data transfer process (YES at Step S237), the MPU 114 continues the determination at Step S237 until the NANDC 113 completes the data transfer process. Processes after Step S238 are the same as those after Step S228.

Upon receipt of a request for recovery from the SLUMBER mode, the SATAC 111 issues an interrupt notification for recovering from the SSD power saving mode to the MPU 114. Upon receipt of the interrupt notification, the MPU 114 instructs the CLKGEN 116 to resume the supply of the clock signal to the SATAC 111, the RAMC 112, and the NANDC 113.

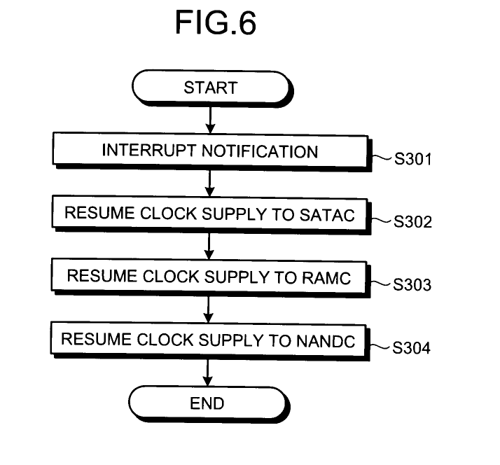

FIG. 6 is a flowchart for explaining an operation of the SSD 100 upon receipt of a request from the Host 200 for recovery from the power saving mode. As shown in FIG. 6, upon receipt of the request from the Host 200 for recovery from the power saving mode, the SATAC 111 issues an interrupt notification for recovering from the SSD power saving mode to the MPU 114 (Step S301). The MPU 114, which has received the notification, instructs the CLKGEN 116 to resume the clock supply to the SATAC 111, the RAMC 112, and the NANDC 113 in this order (Steps S302, S303, and S304).

In this way, upon receipt of the request for shift to the SLUMBER mode or recovery from the SLUMBER mode, the SATAC 111 issues the interrupt notification for shifting to the SSD power saving mode or recovering from the SSD power saving mode to the MPU 114. Upon receipt of the notification, the MPU 114 works together with the CLKGEN 116 to stop or resume the supply of the clock to the SATAC 111, the RAMC 112, and the NANDC 113.

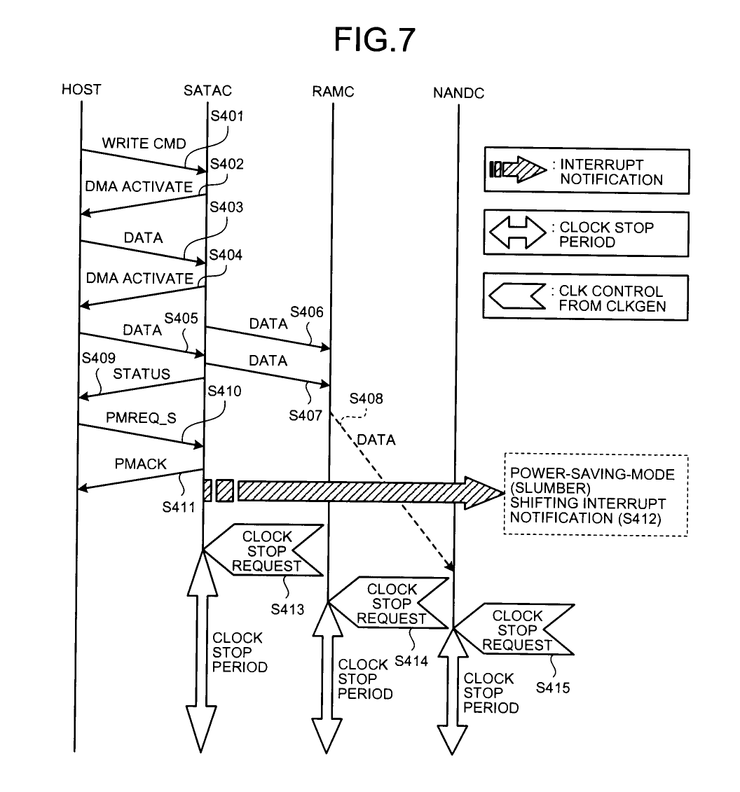

The operation of shifting to or recovering from the SSD power saving mode is explained next more specifically with reference to an operation sequence. FIG. 7 is a sequence diagram for explaining an operation of the SSD 100 for shifting to the SSD power saving mode after performing the operation of writing data stored in the Host 200 to the NAND memory 130. Data to be received from the Host 200 and written into the NAND memory 130 is referred to as “Write data”.

When a Write-data transfer command (Write Cmd) is issued from the Host 200 (Step S401), the SATAC 111 and the MPU 114 interpret Write Cmd to respond to the Host 200 with data transfer permission (DMA Activate) (Step S402). The Host 200, which has received Write Cmd, starts data transfer and transmits the Write data to the SATAC 111 (Step S403). When there is another data transfer request, the SATAC 111 transmits the data transfer permission (DMA Activate) to the Host 200 again (Step S404), and the Host 200 transmits the Write data to the SATAC 111 (Step S405).

Upon receipt of the Write data, the SATAC 111 transmits the Write data to the RAMC 112 to temporarily store the Write data in the RAM 120 (Steps S406 and S407). The RAMC 112 writes the received Write data in the RAM 120.

To store the Write data written in the RAM 120 into the NAND memory 130, the RAMC 112 reads the Write data from the RAM 120. The NANDC 113 receives the read Write data from the RAMC 112 (Step S408). The NANDC 113 writes the received Write data in the NAND memory 130.

The operation of storing the Write data written in the RAM 120 into the NAND memory 130 can be performed in timing independent of Write-Cmd receiving timing. For example, the MPU 114 can control the RAMC 112 and the NANDC 113 to transfer data from the RAM 120 to the NAND memory 130 at predetermined intervals. Alternatively, the MPU 114 can control the RAMC 112 and the NANDC 113 to transfer data from the RAM 120 to the NAND memory 130 when the SATAC 111 receives from the Host device 200, a request (Flush Cache command) for transferring the Write data stored in the RAM 120 to the NAND memory 130.

When the data has been transferred to the RAM 120 or the NAND memory 130, the SATAC 111 transmits Status to notify the Host 200 of completion of the command (Step S409). Upon receipt of Status, the Host 200 recognizes that the operation related to Write Cmd transmitted at Step S401 is finished. When there is no other command to be executed, the Host 200 issues PMREQ_S to request permission for shifting the SATA I/F 300 to the SLUMBER mode (Step S410). The SATAC 111 responds to PMREQ_S with PMACK to permit the SATA I/F 300 to shift to the SLUMBER mode (Step S411). Upon receipt of PMACK, the Host 200 performs a power saving control for the SATA I/F 300.

Upon receipt of PMREQ_S, the SATAC 111 responds with PMACK and issues to the MPU 114, a power-saving-mode (SLUMBER) interrupt notification as an interrupt notification for shifting to the SSD power saving mode (Step S412). Upon recognition of the power-saving-mode (SLUMBER) interrupt notification, the MPU 114 confirms that the SATAC 111 has completed the data transfer process and instructs the CLKGEN 116 to stop the clock supply to the STATC 111 (Step S413). The MPU 114 further confirms that the RAMC 112 has completed the data transfer process and stops the clock supply to the RMAC 112 (Step S414). The MPU 114 further confirms that the NANDC 113 has completed the data transfer process and stops the clock supply to the NANDC 113 (Step S415).

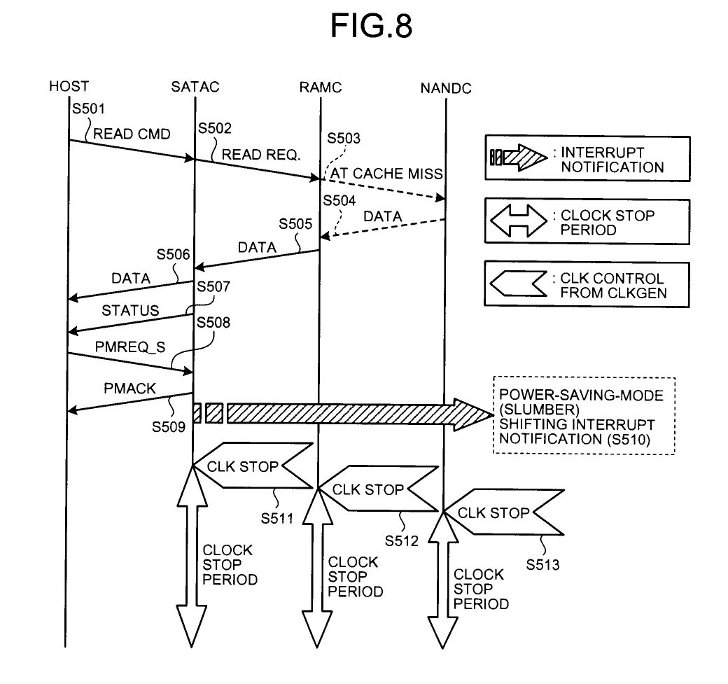

FIG. 8 is a sequence diagram for explaining an operation of the SSD 100 for shifting to the SSD power saving mode after performing an operation of transferring data written in the NAND memory 130 to the Host 200. Data to be read from the NAND memory 130 and transferred to the Host 200 is referred to as “Read data”.

When a Read-data transfer command (Read Cmd) is issued from the Host 200 (Step S501), the SATAC 111 and the MPU 114 interpret Read Cmd. When the Read data requested by the command is already in the RAM 120 (cache hit), the SATAC 111 issues a read request (Read Req.) to the RAMC 112 (Step S502) to read the Read data from the RAM 120. The Read data read from the RAM 120 is transferred to the SATAC 111 (Step S505). When the requested Read data is not in the RAM 120 (cache miss), the MPU 114 issues the read request (Read Req.) to the NANDC 113 (Step S503), and the NANDC 113 reads the Read data in the NAND memory 130. The NANDC 113 transfers the Read data to the RAMC 112 (Step S504). After the RAMC 112 stores the Read data transferred from the NANDC 113 in the RAM 120, the SATAC 111 cause the RAMC 112 to read the Read data and to transfer the Read data to the SATAC 111 (Step S505).

The SATAC 111 transmits the Read data transferred from the RAMC 112 to the Host 200 (Step S506). At the time of cache miss, the Read data read from the NAND memory 130 can be directly transferred from the NANDC 113 to the SATAC 111, without passing through the RAMC 112 and the RAM 120.

Upon completion of the transmission of the Read data to the Host 200, the SATAC 111 transmits Status to notify the Host 200 of completion of the command (Step S507). The Host 200 recognizes that Read Cmd is finished by receiving Status. As the subsequent operation, the same operations at Steps S410 to S415 shown in FIG. 7 are performed at Steps S508 to S513, thereby stopping the clock supply to the SATAC 111, the RAMC 112, and the NANDC 113.

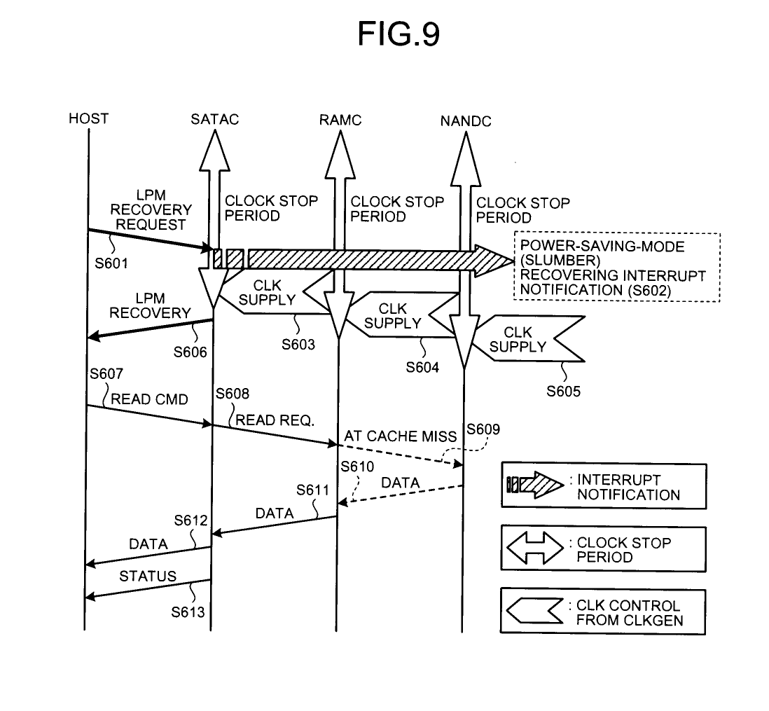

FIG. 9 is a sequence diagram for explaining an operation of the SSD 100 for recovering from the SSD power saving mode. When the SATA I/F 300 is to be recovered from the SLUMBER mode to execute a command related to a data access to the SSD 100 or the like, the Host device 200 issues an LPM recovery request (Step S601). Upon receipt of the LPM recovery request, the SATAC 111 issues to the MPU 114, a power-saving mode (SLUMBER) recovering interrupt notification as a notification for recovering from the SSD power saving mode (Step S602). Upon detection of the power-saving-mode (SLUMBER) recovering interrupt notification, the MPU 114 instructs the CLKGEN 116 to resume the clock supply to the SATAC 111, the RAMC 112, and the NANDC 113, respectively (Steps S603, S604, and S605). When the clock supply to the SATAC 111 is resumed, the SATAC 111 transmits an LPM recovery as a response to the LPM recovery request to the Host 200 (Step S606).

Upon receipt of the LPM recovery, the Host 200 issues a command when it is ready to issue the command, and the device performs a predetermined operation according the received command as usual. For example, as shown in FIG. 9, the same operations at Steps S501 to S507 shown in FIG. 8 can be performed at Steps S607 to S613, thereby reading data from the NAND memory 130.

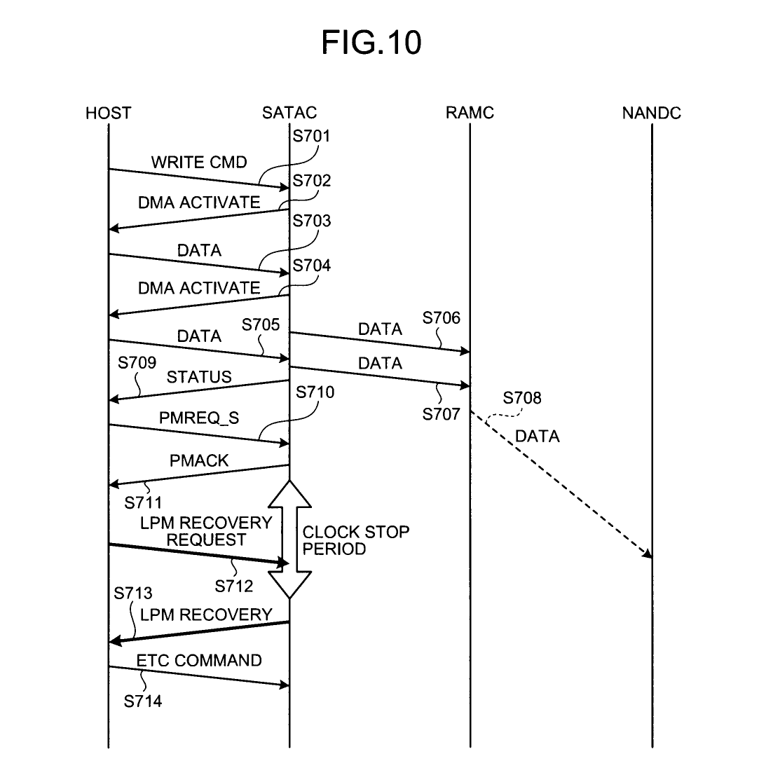

For comparison with the sequence diagrams of the operations of the SSD 100 as described above, an example of an operation of a conventional SSD for shifting to a power saving mode is explained. FIG. 10 is a sequence diagram for explaining an example of the operation of the conventional SSD for shifting to the power saving mode. Operations at Steps S701 to S711 are the same as those at Steps S401 to S411 shown in FIG. 7. When receiving PMREQ_S at Step S710, a conventional SATAC responds to PMREQ_S with PMACK (Step S711). A SATA I/F then stops clock supply to some circuits of the SATAC, and only the SATA I/F shifts to the power saving mode. Upon receipt of an LPM recovery request (Step S712), the SATAC resumes the stopped clock supply to some circuits of the SATAC to recover from the power saving mode and transmits an LPM recovery to a Host (Step S713). The SATAC then receives various commands (ETC command) from the Host (Step S714).

As described above, according to the conventional technique, only the SATAC (SATA interface circuit) shifts to the power saving mode in response to a request transmitted from the Host device for shift to the power saving mode defined in the SATA standard. Therefore, during the power saving mode, the RMAC and the NANDC are supplied with a clock and wait for data transmission or reception although no data transmission or reception is performed. On the other hand, in the SSD 100 according to the present embodiment, the clock to the RAMC 112 and the NANDC 113 is stopped in conjunction with the power consumption control of the SATAC 111 as shown in FIGS. 8 to 10. Therefore, the power consumption can be reduced by an amount of power consumed to supply the clock to the RAMC 112 and the NANDC 113, as compared to the conventional technique. That is, the power consumption during the power saving mode can be reduced as much as possible.

In the above explanations, upon receipt of the request from the Host device for shift to the SLUMBER mode, the SATAC 111 transmits to the MPU 114, the notification for shifting to the SSD power saving mode based on the received request. However, the SATAC 111 can monitor the SATA I/F 300 and transmit to the MPU 114, the notification for shifting to the SSD power saving mode when transmission or reception of data and commands to/from the Host device 200 stops.

As described above, according to the present embodiment, the power saving control of stopping the clock supply to the SATAC 111, the RAMC 112, and the NANDC 113 is performed in conjunction with the power consumption control of the SATAC 111. Therefore, the data storage device that reduces the power consumption during the power saving mode as much as possible can be provided.

In the above explanations, the data storage device includes the RAM 120 that temporarily stores therein the transfer data, and the RAMC 112 that controls the RAM 120. However, the NANDC 113 and the SATAC 111 can directly transfer the transfer data to each other, without using the RAM 120 and the RAMC 112.

In the above explanations, the clock supply to the SATAC 111, the RAMC 112, and the NANDC 113 is stopped when the request for shift to the SLUMBER mode among the power saving modes defined in the SATA standard is received. However, when the device can be recovered in a recovery time equal to or shorter than 10 microseconds, the clock supply to the SATAC 111, the RAMC 112, and the NANDC 113 can be stopped upon receipt of a request for shift to the PARTIAL mode.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data storage device comprising:
a first nonvolatile memory;
a second volatile memory that temporarily stores therein data to be transferred between a host device and the first memory;
a first control unit that controls the second memory;
a second control unit that controls data transfer between the first control unit and the first memory;
a third control unit that controls data transfer between the host device and the first control unit; and
a clock stop unit that stops a clock signal supplied to the first to third control units in conjunction with a power consumption control of the third control unit to perform a power saving control.

2. The data storage device according to claim 1, wherein
the third control unit issues an interrupt notification for performing the power saving control to the clock stop unit upon receipt of a request from the host device for the power saving control, and
the clock stop unit that has received the interrupt notification for performing the power saving control stops the clock signal supplied to the first to third control units.

3. The data storage device according to claim 2, wherein
the third control unit is a serial advanced technology attachment (SATA) interface controller that controls data transfer meeting a SATA standard, and
the request for the power saving control includes a request for shifting to a SLUMBER mode.

4. The data storage device according to claim 3, wherein the request for the power saving control includes a request for shifting to a PARTIAL mode.

5. The data storage device according to claim 1, wherein
the first control unit includes a refreshing unit that refreshes the second memory, and
the clock stop unit does not stop a clock signal supplied to the refreshing unit even at a time of the power saving control.

6. The data storage device according to claim 2, wherein
the third control unit includes a request receiving unit that receives a request from the host device for recovery from a power saving control state and that is supplied with a clock signal even at the time of the power saving control,
the third control unit issues an interrupt notification for recovering from the power saving control state to the clock stop unit when the request receiving unit receives the request for recovery from the power saving control state, and
the clock stop unit that has received the interrupt notification for recovering from the power saving control state resumes the supply of the clock signal to the first to third control units.

7. A data storage device comprising:
a nonvolatile memory;
a first control unit that controls the memory;
a second control unit that controls data transfer between a host device and the first control unit; and
a clock stop unit that stops a clock signal supplied to the first and second control units in conjunction with a power consumption control of the second control unit to perform a power saving control.

8. The data storage device according to claim 7, wherein
the second control unit issues an interrupt notification for performing the power saving control to the clock stop unit upon receipt of a request from the host device for the power saving control, and
the clock stop unit that has received the interrupt notification for performing the power saving control stops the clock signal supplied to the first and second control units.

9. The data storage device according to claim 8, wherein
the second control unit is a serial advanced technology attachment (SATA) interface controller that controls data transfer meeting a SATA standard, and
the request for the power saving control includes a request for shifting to a SLUMBER mode.

10. The data storage device according to claim 9, wherein the request for the power saving control includes a request for shifting to a PARTIAL mode.

11. The data storage device according to claim 8, wherein
the second control unit includes a request receiving unit that receives a request from the host device for recovery from a power saving control state and that is supplied with a clock signal even at a time of the power saving control, and issues an interrupt notification for recovering from the power saving control state to the clock stop unit when the request receiving unit receives the request for recovery from the power saving control state, and
the clock stop unit that has received the interrupt notification for recovering from the power saving control state resumes the supply of the clock signal to the first and second control units.

12. A power-saving control method for a data storage device that includes a first nonvolatile memory, a second volatile memory that temporarily stores therein data to be transferred between a host device and the first memory, a first control unit that controls the second memory, a second control unit that controls data transfer between the first control unit and the first memory, and a third control unit that controls data transfer between the host device and the first control unit,
the power-saving control method comprising stopping a clock signal supplied to the first to third control units in conjunction with a power consumption control of the third control unit to perform a power saving control.

13. The power-saving control method for a data storage device according to claim 12, wherein
the third control unit issues an interrupt notification for performing the power saving control upon receipt of a request from the host device for the power saving control, and
the clock signal supplied to the first to third control units is stopped when the third control unit issues the interrupt notification for performing the power saving control.

14. The power-saving control method for a data storage device according to claim 13, comprising stopping the supply of the clock signal to the third control unit, the first control unit, and the second control unit in this order when the third control unit issues the interrupt notification for performing the power saving control.

15. The power-saving control method for a data storage device according to claim 14, comprising:
when the third control unit issues the interrupt notification for performing the power saving control,
determining whether the third control unit is performing data transfer, and stopping the clock signal supplied to the third control unit when the third control unit is not performing the data transfer;
determining whether the first control unit is performing data transfer, and stopping the clock signal supplied to the first control unit when the first control unit is not performing the data transfer; and
determining whether the second control unit is performing data transfer, and stopping the clock signal supplied to the second control unit when the second control unit is not performing the data transfer.

16. The power-saving control method for a data storage device according to claim 13, wherein
the third control unit is a serial advanced technology attachment (SATA) interface controller that controls data transfer meeting a SATA standard, and
the request for the power saving control includes a request for shifting to a SLUMBER mode.

17. The power-saving control method for a data storage device according to claim 16, wherein the request for the power saving control includes a request for shifting to a PARTIAL mode.

18. The power-saving control method for a data storage device according to claim 12, wherein
the first control unit includes a refreshing unit that refreshes the second memory, and
a clock signal supplied to the refreshing unit is not stopped even at a time of the power saving control.

19. The power-saving control method for a data storage device according to claim 13, wherein
the third control unit includes a request receiving unit that receives a request from the host device for recovery from a power saving control state and that is supplied with a clock signal even at the time of the power saving control,
the third control unit issues an interrupt notification for recovering from the power saving control state when the request receiving unit receives the request for recovery from the power saving control state, and
the supply of the clock signal to the first to third control units is resumed when the third control unit issues the interrupt notification for recovering from the power saving control state.
